(19) United States
(12) Patent Application Publication
(10) Pub. No.: US 2025/0222832 A1
(43) Pub. Date: Jul. 10, 2025

(54) VEHICLE CONTROL DEVICE, VEHICLE CONTROL SYSTEM, CONTROL METHOD, AND STORAGE MEDIUM THEREOF

(71) Applicant: DENSO CORPORATION, Kariya-city (JP)

(72) Inventors: Ataro YAMADA, Kariya-city (JP); Kei OKADA, Kariya-city (JP)

(21) Appl. No.: 19/096,514

(22) Filed: Mar. 31, 2025

Related U.S. Application Data
(63) Continuation of application No. PCT/JP2023/036633, filed on Oct. 6, 2023.

(30) Foreign Application Priority Data
Oct. 17, 2022 (JP) 2022-166149

(51) Int. Cl. B60N 2/02

(52) U.S. Cl. CPC B60N 2/0248; B60N 2/0272

(57) ABSTRACT

The control device includes a storage unit, an input unit, and a control unit. The storage unit stores location information record indicating mounting location of each equipment, which includes row location information indicating a mounting location in front-rear direction of vehicle and lateral location information indicating the mounting location in left-right direction of vehicle. The input unit receives a control request to control equipment or vehicle-mounted component correlated to the equipment. The equipment is identified by identification information that defines a front-rear order in front-rear direction of the vehicle and a left-right order in left-right direction of the vehicle. The control unit determines and controls a control target, which is determined as the equipment or vehicle-mounted component correlated to the equipment according the control request based on the identification information included in the control request and the location information stored in the storage unit.

### CROSS REFERENCE TO RELATED APPLICATIONS

The present application is a continuation application of International Patent Application No. PCT/JP2023/036633 filed on Oct. 6, 2023, which designated the U.S. and claims the benefit of priority from Japanese Patent Application No. 2022-166149 filed on Oct. 17, 2022. The entire disclosures of all of the above applications are incorporated herein by reference.

### TECHNICAL FIELD

The present disclosure relates to a vehicle control device, a vehicle control system, a control method, and a storage medium thereof.

### BACKGROUND

Conventionally, a control device enables a remote control of a vehicle equipment, such as an electric power seat, to start operation using a remote controller.

### SUMMARY

The present disclosure provides a vehicle control device. The vehicle control device includes a storage unit storing location information records indicating mounting locations of multiple pieces of equipment mounted on a vehicle. Each of the location information records includes row location information indicating a location of the corresponding equipment in a front-rear direction of the vehicle and lateral location information indicating a location of the corresponding equipment in a left-right direction of the vehicle. The vehicle control device is configured to receive a control request to control one of the multiple pieces of equipment or a vehicle-mounted component correlated to the one of the multiple pieces of equipment. The one of the multiple pieces of equipment is identified by identification information that defines a front-rear order indicating an order in the front-rear direction of the vehicle and a left-right order indicating an order in the left-right direction of the vehicle, and the identification information is prepared for the vehicle and another vehicle that has different number and different arrangement of multiple pieces of equipment from the vehicle. The vehicle control device is configured to determine a control target and perform a control to the control target. The control target is determined as one of the multiple pieces of equipment or the vehicle-mounted component correlated to the one of the multiple pieces of equipment according to the control request based on the identification information included in the control request and the location information stored in the storage unit.

### BRIEF DESCRIPTION OF DRAWINGS

The present disclosure will become apparent from the following detailed description made with reference to the accompanying drawings.

FIG. 1 is a block diagram showing an overall configuration of a vehicle control system according to an embodiment.

FIG. 2 is an explanatory diagram showing a seat arrangement in a vehicle compartment and location information of each seat.

FIG. 3 is an explanatory diagram showing a method of setting seat location information.

FIG. 4 is an explanatory diagram showing a problem that occurs when seat row location information is set in sequence from the left side of a vehicle.

FIG. 5 is an explanatory diagram showing an installation state of an electric power seat that constitutes a seat of the vehicle.

FIG. 6 is an explanatory diagram showing management data including seat location information.

FIG. 7 is an explanatory diagram showing spatial coordinates of seats.

FIG. 8 is an explanatory diagram showing a problem that occurs when a seat is moved in a vehicle in which seat row location information is set in sequence from the left side of the vehicle.

FIG. 9 is a flowchart showing a control operation executed by a body system controller.

FIG. 10 is a flowchart showing an update operation of management data.

FIG. 11 is an explanatory diagram illustrating a modification example of a setting method of location information.

### DETAILED DESCRIPTION

There is known a control device that enables a remote control of a vehicle equipment, such as an electric power seat, to start operation of vehicle equipment using a remote controller. In this kind of control device, a code for identifying a target equipment to be controlled is added to an operation signal transmitted from the remote controller. When the control device receives the operation signal from the remote controller, the control device identifies the target equipment based on the code added to the operation signal, and controls the identified equipment in response to the operation signal.

In the above-described control device, the target equipment to be controlled in response to the operation signal is identified by the code preliminarily assigned to the equipment. Thus, the equipment code cannot be standardized among different vehicles that have different number or locations of equipment to be controlled.

Usually, application software implemented by program is used to generate control requests such as operation signals in an input unit, such as a remote controller. When the equipment code cannot be standardized among different vehicles, the application software needs to be configured for each vehicle type that has the same number of equipment or the same arrangement of equipment. Therefore, in a vehicle equipped with the above-described control device, management of the program to be installed in the input unit may become complicated.

According to an aspect of the present disclosure, a vehicle control device includes a storage unit, an input unit, and a control unit.

The storage unit stores location information records indicating mounting locations of multiple pieces of equipment mounted on a vehicle. Each of the location information records includes row location information indicating a location of the corresponding equipment in a front-rear direction of the vehicle and lateral location information indicating a location of the corresponding equipment in a left-right direction of the vehicle.

The input unit receives a control request to control one of the multiple pieces of equipment or a vehicle-mounted component correlated to the one of the multiple pieces of equipment. The one of the multiple pieces of equipment is identified by identification information that defines a front-rear order indicating an order in the front-rear direction of the vehicle and a left-right order indicating an order in the left-right direction of the vehicle.

The control unit determines a control target and performs a control to the control target, the control target being determined as one of the multiple pieces of equipment or the vehicle-mounted component correlated to the one of the multiple pieces of equipment according to the control request based on the identification information included in the control request and the location information stored in the storage unit.

In the above control device according to the present disclosure, as information for identifying one of the multiple pieces of equipment mounted on the vehicle, the location information, which has the row location information indicating the location in the front-rear direction of the vehicle and the lateral location information indicating the location in the left-right direction of the vehicle, is used, rather than a preset code assigned to each equipment in advance.

The control unit determines the control target and performs control to the control target corresponding to the control request. The control target is determined as the equipment corresponding to the control request or the vehicle-mounted component correlated to the equipment corresponding to the control request based on the identification information included in the control request input from the input unit and the location information stored in the storage unit.

Therefore, even when the number or arrangement of equipment installed in the vehicle is different in different types of vehicles, the control unit can identify the equipment or vehicle-mounted component as the control target based on the identification information included in the control request received by the input unit.

According to the control device of the present disclosure, even when the program used to generate the control request accepted by the input unit is standardized between vehicles having different numbers or arrangements of equipment, it is possible to properly specify the equipment or vehicle-mounted component to be controlled by the control unit. Thus, the control device of the present disclosure enables standardization among vehicles having different numbers of equipment or different arrangements of equipment.

According to another aspect of the present disclosure, a program that enables identification of a specific equipment from multiple pieces of equipment mounted on the vehicle and generation of a control request to control the identified equipment is provided.

The following will describe an embodiment of the present disclosure with reference to the drawings.

### Configuration

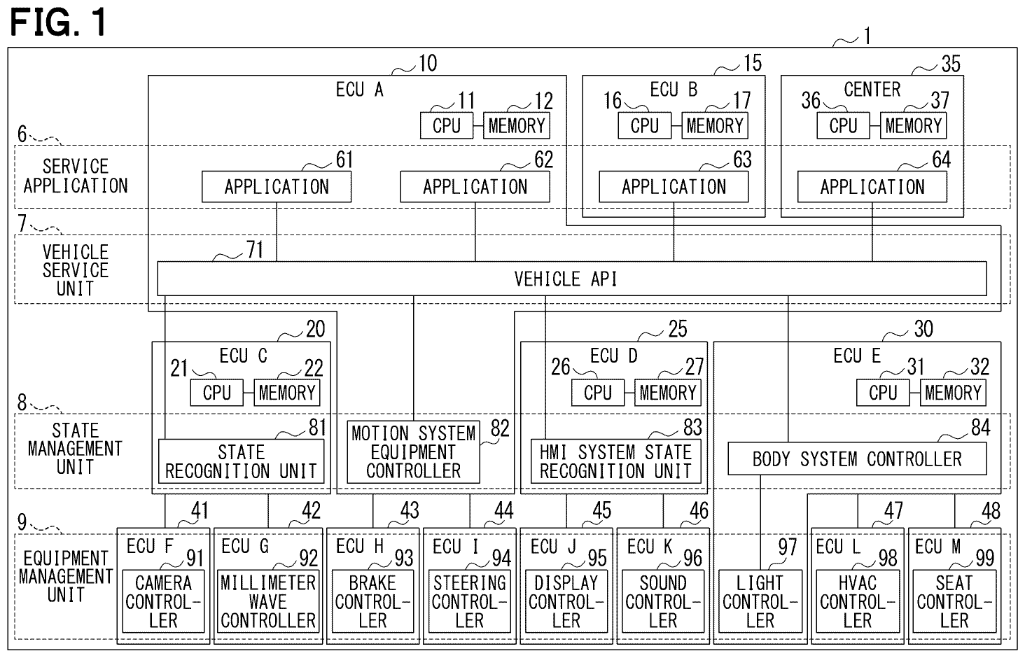

As shown in FIG. 1, most components of a vehicle control system 1 are mounted on a vehicle, such as a passenger car, and include multiple ECUs 10, 15, 20, 25, 30, 41 to 48 (hereinafter referred to as multiple ECUs 10). The vehicle control system 1 may include a center device (hereinafter, referred to as the center) 35 located outside the vehicle.

The center 35 is implemented by a server, which is capable of providing a function to the vehicle. For example, the center 35 can provide the vehicle with a function related to automated driving.

Each of the multiple ECUs 10 and the center 35 mainly include a microcomputer. Each microcomputer includes a CPU 11, 16, 21, 26, 31, 36 (hereinafter the CPUs are referred to as CPUs 11 to 36) and a semiconductor memory 12, 17, 22, 27, 32, 37 (hereinafter the semiconductor memories are referred to as memories 12 to 37). The semiconductor memory may be a RAM, a ROM, or a flash memory. Each of the ECUs 41 to 48 also includes a CPU and a memory, but detailed configurations are not shown in the drawings. ECU indicates electronic control unit.

The multiple ECUs 10 and the center 35 are configured to control a control target mounted on the vehicle. The control target includes various types of equipment, such as the engine, brake, motor, various lights, display devices, air conditioners, electric power seats, horn, and generator. Note that illustration of the control target is omitted in the drawing.

Multiple control targets are respectively controlled by the ECUs 41 to 48, which correspond to operation control devices. The ECUs 41 to 48 include an ECUF 41 having a camera controller 91, an ECUG 42 having a millimeter wave controller 92, an ECUH 43 having a brake controller 93, and an ECUI 44 having a steering controller 94. The ECUs 41 to 48 also include an ECUJ 45 having a display controller 95, an ECUK 46 having a sound controller 96, an ECUL 47 having an HVAC controller 98, and an ECUM 48 having a seat controller 99.

Each of the controllers 91 to 99 includes an operation control program for operating a control target. The camera controller 91 acquires a captured image of a vehicle-mounted camera and controls exposure and the like of the vehicle-mounted camera. The millimeter wave controller 92 controls a millimeter wave radar equipped to the vehicle and acquires a detection result obtained by the millimeter wave radar.

The brake controller 93 controls a brake. The steering controller 94 controls steering. The display controller 95 controls a display, such as a meter or a warning light. The sound controller 96 controls a sound such as a warning sound and a voice generated from a speaker. The light controller 97 controls various lights mounted on the vehicle. Note that the light controller 97 is included in the ECUE 30.

The HVAC controller 98 controls a vehicle air conditioner. Note that HVAC is an abbreviation for Heating Ventilation and Air-Conditioning. The seat controller 99 controls the electric power seat that constitute one or more seats of the vehicle.

Various functions of multiple ECUs 10 and the center 35 are implemented by the CPUs 11 to 31 executing a program stored in a non-transitory tangible storage medium. In this example, the memories 12 to 32 correspond to the non-transitory tangible storage medium that store the programs. By executing the program corresponding to the function of controller, a method corresponding to the program is executed. Note that the non-transitory tangible storage medium means a storage medium excluding electromagnetic waves. The number of microcomputers constituting the multiple ECUs 10 and the like and the center 35 may be one or more.

Among the multiple ECUs 10, the ECU A 10 implements functions of a vehicle API 71 and a motion system equipment controller 82 by application software (hereinafter referred to as application) 61 and 62. The ECUB 15 implements a predetermined function by an application 63. The center 35 implements a predetermined function by an application 64.

The applications 61 to 64 each is a program for providing a service to a user of the vehicle. The applications 61 to 64 each indirectly transmits a command to the control target and provides a useful function to the user by operating the control target. These applications 61 to 64 may be installed in the ECUA 10. Alternatively, the applications 61 to 64 may be installed in the ECUB 15. Alternatively, the applications 61 to 64 may be installed in the center 35.

The applications 61 to 64 each is configured to generate a first command that is a command not designating the controller 91 to 99 toward the vehicle API 71. Details about the first command will be described later. Note that the command includes an operation request command, a command having an argument, and a function call, among data to be used by the vehicle API 71. The command may include priority information indicating which command should be preferentially processed.

Each of the applications 61 to 64 is not a dedicated program generated for a specific vehicle type, a specific grade, or the like. Each of the applications 61 to 64 is a general-purpose program that can support various types of vehicles, various grades, or the like. Thus, each of the applications 61 to 64 cannot specify how the vehicle in which the application is installed controls the control target. Therefore, each of the applications 61 to 64 outputs a command, which does not define a specific control amount of the control target. In other words, each of the applications 61 to 64 outputs a command, which does not designate the controller 91 to 99 to be used by the vehicle API 71. On the other hand, the applications 61 to 64 generate desired abstract operation contents and output them as commands.

The applications 61 to 64 each may not include in their operation details which light is to be turned on, such as turning on all lights mode. The applications 61 to 64 each may include in their operation details which light is to be turned on, such as turning on a specific light.

In the following description, at least one of the applications 61 to 64 is also referred to as a service application 6.

Unlike the applications 61 to 64, the vehicle API 71 is a program prepared for a specific vehicle type, a specific grade, or the like. That is, the vehicle API 71 is a program that absorbs difference in vehicle types, grades, or the like such that the applications 61 to 64 do not need to recognize the difference in vehicle types, grades, or the like. The vehicle API 71 is a program that functions as an API for adapting a command used by each of the applications 61 to 64 and a command used by a state management unit 8 and an equipment management unit 9 to be described later. API is an abbreviation for Application Programming Interface.

The vehicle API 71 is installed in the ECUA 10. The vehicle API 71 receives commands from multiple applications 61 to 64. The multiple applications 61 to 64 are installed in the ECUA 10 that includes the vehicle API 71, the ECUB 15 that is another ECU, and the center 35.

Hereinafter, at least one of the vehicle APIs 71 is also referred to as a vehicle service unit 7. Note that the vehicle service unit 7 may include multiple vehicle APIs.

The ECUC 20 implements a function as a state recognition unit 81. The ECUD 25 implements a function as an HMI system state recognition unit 83. The ECUE 30 implements a function as a body system controller 84. Hereinafter, at least one of the state recognition unit 81, the motion system equipment controller 82, the HMI system state recognition unit 83, or the body system controller 84 is also referred to as the state management unit 8.

The state management unit 8 is one of programs for controlling the control target. The state management unit 8 may calculate an operation amount of an actuator, which corresponds to the control target, and transmits a command including the operation amount, to the various controllers 91 to 99. The state management unit 8 has a function of generating a second command, which specifies the generalized first command, in response to input of the generalized first command. Note that the vehicle service unit 7 may have a function of generating the second command, which specifies the first command. The state management unit 8 may be provided for each functional domain and have an arbitration function for the actuators of each domain.

The state management unit 8 is also a program for transmitting data obtained from sensors to the service application 6. The state management unit 8 implements data collection function and control instruction function. The data collection function converts sensor data obtained from the equipment management unit 9 (each controller 91 to 99 to be described later) into a format suitable for the vehicle service unit 7, and transmits the converted data to the vehicle service unit 7. In the control instruction function, a drive instruction from the vehicle service unit 7 is distributed to the equipment management unit 9.

The state management unit 8 may be installed in the same ECUA 10 as the ECU in which the vehicle API 71 is installed. Alternatively, the state management unit 8 may be installed in the ECUC 20, ECUD 25, or ECUE 30, which corresponds to another ECU. All components of the state management unit 8, which includes at least one of the state recognition unit 81, the motion system equipment controller 82, the HMI system state recognition unit 83, and the body system controller 84, may be installed in the same ECUA 10 as the ECU in which the vehicle API 71 is installed. Alternatively, the state management unit 8 may be installed in distributed manner, that is, in each ECU that controls each domain.

In the state recognition function, individual sensor raw data acquired by the equipment management unit 9 from the vehicle sensors are classified into data for each sensing target such that the service application 6 can easily use the classified data. The state recognition function also integrates the data such that the data can be converted into information with a higher generalization level, and then transmits the information to the vehicle service unit 7.

For example, in the state recognition function, each of the controllers 91 to 99 constituting the equipment management unit 9 acquires individual information element, such as a vehicle speed of 0 km/h, a shift position of P, and absence of a driver in the vehicle, and outputs a signal indicating that the vehicle is in a parked state on the basis of these information elements. These information elements are further transmitted to the service application 6 via the vehicle service unit 7.

For example, when the service application 6 makes a request regarding a car finder service, the vehicle service unit 7 may respond to the service application 6 by combining an ACK from the light, which is a response to a control request of light, and an ACK from the horn, which is a response to a control request of horn, into a single operation result. The car finder is a function that notifies the user of the location of the vehicle in a parking lot or the like in an easy-to-understand manner.

In the function of the equipment control, each of the controllers 91 to 99 (for example, an engine, a steering, a shift, a door, a window, an air conditioner, or the like) in the optimal equipment management unit 9 is selected in order to implement the vehicle operation request from the service application 6. The equipment control function converts the data format into a format that can be received by each of the controllers 91 to 99, and distributes the data with consideration of transmission order of data.

For example, when the vehicle operation request is “turn left with a radius of 200 meters and acceleration of 0.3 G”, the equipment control function outputs “request engine output of 1000 Nm and request steering output of −0.1 rad”.

For example, the vehicle operation request may be “transition to a parking state”. In this case, the equipment control function outputs “request for setting a shift to P, a request for an air conditioner to be off, a request for a window to be fully closed, a request for a door to be locked when the requests described above are completed and there is no occupant in the vehicle, and then a request for transition to a parking state”.

The state management unit 8 is divided into multiple programs such that each program corresponds to each type of vehicle operation. Each type of vehicle operation corresponds to each type of the first command. The type of vehicle operation includes, for example, a traveling system related to turning, traveling, and stopping of the vehicle, an HMI system related to information presentation to the user, a body system related to a state change of the body, and the like. As described above, in the state management unit 8, each of management functions 81 to 84 is provided according to the type of domain. The programs of the management functions are stored in the memory 22 of the ECUC 20, the memory 27 of the ECUD 25, the memory 32 of the ECUE 30, or the memory 12 of the ECUA 10. The ECUC 20, ECUD 25, and ECUE 30 each corresponds to a domain control unit. The ECUA 10 corresponds to the central unit.

The state management unit 8 is classified for each vehicle operation that is likely to be requested by the service application 6, but not for each implementation function (for example, the controllers 91 to 99) that is likely to depend on the vehicle variation.

The state recognition unit 81 acquires information from the camera controller 91 and the millimeter wave controller 92, converts the acquired information into information indicating the positions of the vehicle and the pedestrian, and outputs the converted information to the vehicle service unit 7.

The motion system equipment controller 82 converts the operation request of the vehicle into specific control amounts of the brake controller 93 and the steering controller 94, and outputs the converted control amounts.

The HMI system state recognition unit 83 determines, in response to a reception of warning command, whether to perform notification using the display controller 95 and the sound controller 96, and outputs the corresponding control amount.

For example, the body system controller 84 determines, in response to a reception of a command related to the vehicle environment, which one of the light controller 97, the HVAC controller 98, the seat controller 99 is to be operated. Then, the body system controller converts the command related to the vehicle environment into an appropriate command, and then outputs the converted command.

As described above, the architecture within the vehicle network is configured in layered manner, such that the first layer is the equipment management unit 9, the second layer is the state management unit 8, the third layer is the vehicle service unit 7, and the fourth layer is the service application 6.

The equipment management unit 9 drives and controls various types of equipment mounted on the vehicle, which correspond to the control targets. The equipment management unit 9 controls an operation of equipment in accordance with instruction from the state management unit 8. The vehicle service unit 7 identifies an equipment to be controlled in response to a vehicle operation request input from the service application 6, and outputs a control request to the state management unit 8 for controlling the target equipment.

In the above-described vehicle control system 1, the functions of the control device according to the present disclosure is implemented by the ECUE 30 and the ECUM 48. The ECUE 30 has the body system controller 84 in the state management unit 8, and the ECUM 48 has the seat controller 99 in the equipment management unit 9.

The following will describe a configuration for implementing the functions of control device according to the present disclosure by the ECUE 30 and the ECUM 48

### Functional Configuration of Control Device

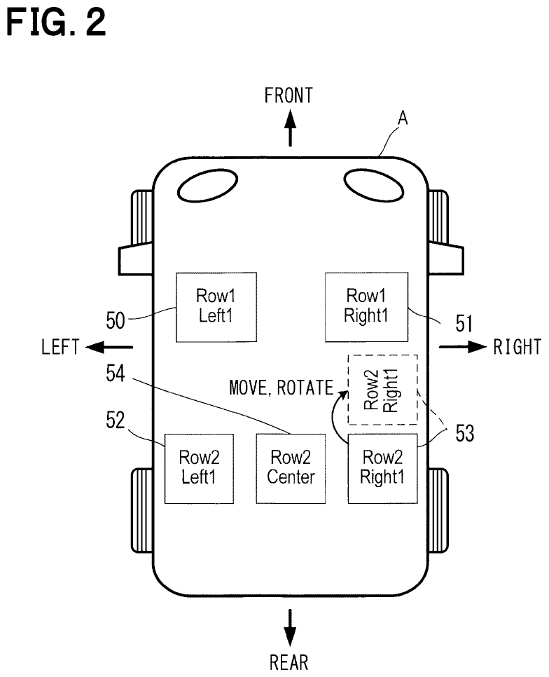

In the present embodiment, as shown in FIG. 2, the vehicle A has seats 50 and 51 arranged on the left and right at a front portion of the vehicle compartment, and seats 52 to 54 arranged on the left, center, right at a rear portion of the vehicle compartment.

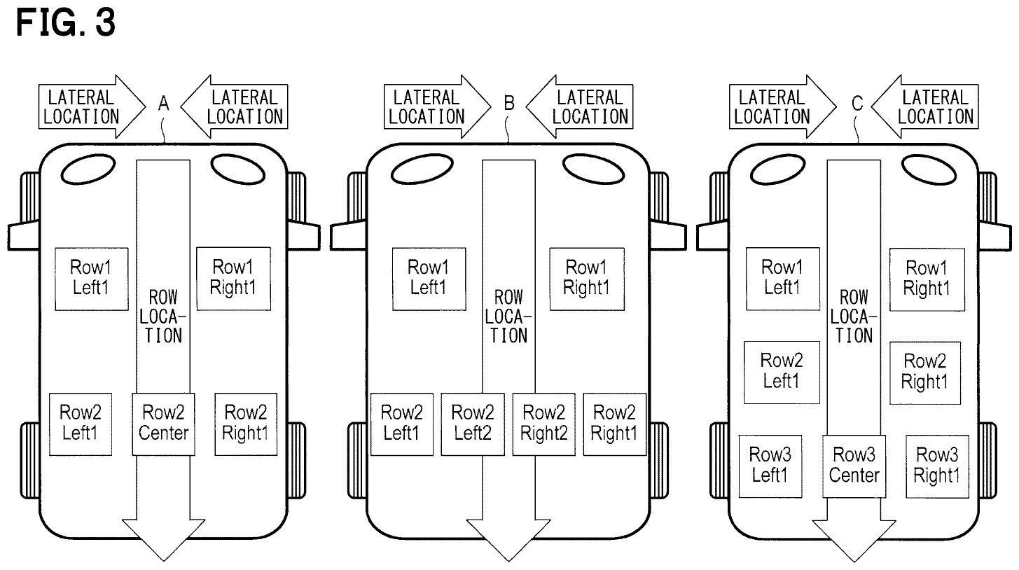

Each of the five seats 50 to 54 is set with location information that indicates the location of seat within the vehicle compartment. The location information includes row location information indicating the location of vehicle A in the longitudinal direction of the vehicle. The location information includes lateral location information indicating the location of vehicle A in the lateral direction of the vehicle. As shown in FIG. 3, the lateral location information is set as Row 1, Row 2, . . . in order from the front portion toward the rear portion of the vehicle. The frontmost seat at the front portion of the vehicle compartment is set to Row 1. The lateral location information is set from the window side seat on either the left or right side of the vehicle as left 1 or right 1, and the lateral location information is set in order toward inward direction of the vehicle.

When the seat is arranged on left side relative to the center portion in the left-right direction of the vehicle, the lateral location information is set as Left 1, Left 2, . . . in order from the outer left side toward inward direction of the vehicle. When the seat is arranged on right side relative to the center portion in the left-right direction of the vehicle, the lateral location information is set as Right 1, Right 2, . . . in order from the outer right side toward inward direction of the vehicle. For a seat located at the center portion in the left-right direction of the vehicle, the lateral location information is set to “Center.”

In the present embodiment, for example, the location information of the seat 51 located close to the right window in the front row is set as “Row1, Right1”, and the location information of the seat 54 in the center of the rear row is set as “Row2, Center”.

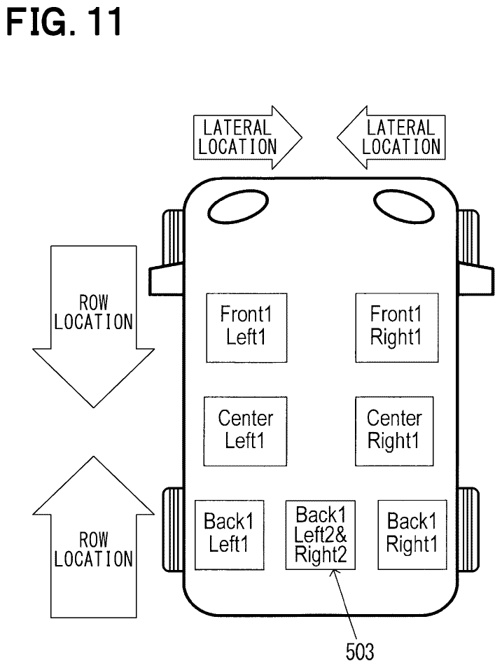

Note that the term “Row”, which indicates row location and the terms “Left”, “Right”, and “Center”, which indicate lateral locations, are used to easily explain the method of setting seat locations, and the location information actually used utilizes symbols that can identify the row location and lateral location of the seat. Therefore, in vehicles A and C shown in FIG. 3, for the seat located in the center of the vehicle in the left-right direction, the lateral location information may be set to “Left 2 & Right 2” as the seat 503 shown in FIG. 11.

The above-described method of setting location information of seat may be adopted in other vehicles that have a different number of seats or a different arrangement of seats, from the vehicle A.

The vehicle B has two seats in the front row and four seats in the second row. Similar to the location information of vehicle A, the row location information of the seats in front row of vehicle B is set to Row 1, and the lateral information of the seats of vehicle B in front row is set as Left 1 for the left side seat, and Right 1 for the right side seat. The vehicle has four seats in the second row. The row location information of the seats in the second row is set to Row 2. The lateral location information of the seats in the second row are set to Left1 and Right1 for the outer side left and right seats. The lateral location information of the seats in the second row are set to Left 2 and Right 2 for the inner side left and right seats.

The vehicle C has seats arranged in three rows. In each of the first and second row, two seats are arranged on left and right, and three seats are arranged in the third row. The row location information of seats starts from the first row, and are set to Row 1, Row 2, and Row 3, in order. The lateral location information of each seat is set to Left 1 for the outer left seat, and is set to Right 1 for the outer right seat. The lateral information of the center seat in the third row is set to Center.

The lateral location information is set so that the order of arrangement from the outer left and right of the vehicle A, B, C can be determined in order to enable accurate selection of seat location on the left or right side of the vehicle in accordance with a control request, even for vehicles with different numbers and arrangements of seats.

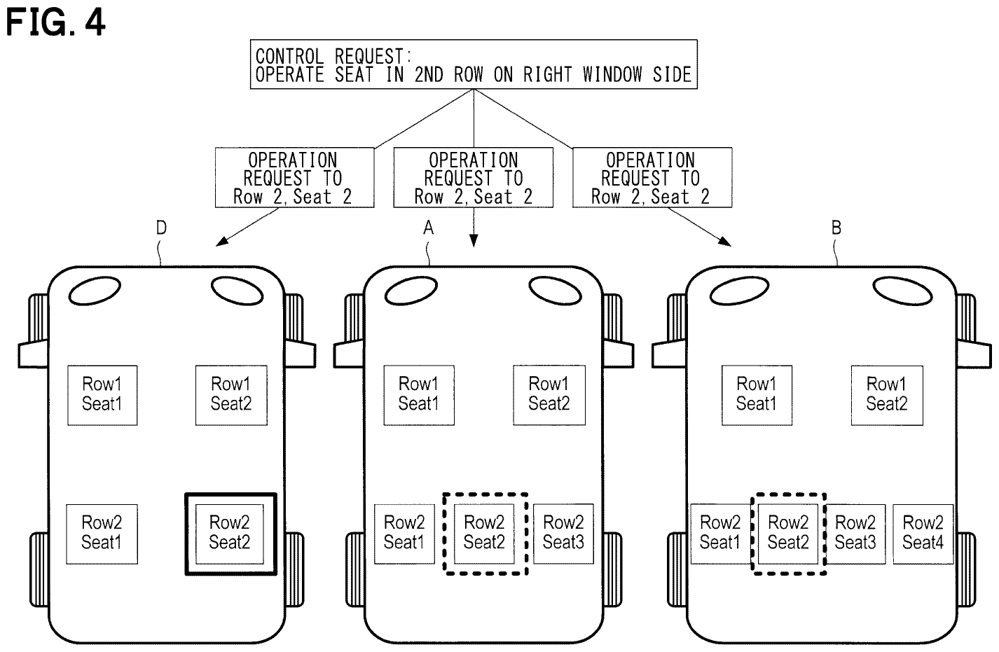

As illustrated in FIG. 4, when the lateral location information is set in order from the left side to the right side of the vehicle, such as Seat 1, Seat 2, . . . , the location of seat “Row 2, Seat 2” is different in vehicles D, A, and B, when the vehicles D, A, and B have different numbers of seats in the second row.

For example, when a user intends to operate the seat on the right window side of the second row, if a control request to operate the seat set as “Row 2, Seat 2” is input, seats in different locations will be selected as the control targets in vehicles D, A, and B, which have different numbers of seats in the second row.

The vehicle D has two seats in the second row, the seat close to the right window in the second row is selected as the control target corresponding to the request by the user. In the vehicle A, since there are three seats in the second row, the seat in the center of the second row is selected as the control target. In the vehicle B, since there are four seats in the second row, the seat on the immediately left side relative to the center of the second row is selected.

As described above, when the lateral location information is set with the left side or right side of vehicle as a start point, it is difficult to select the requested seat in the vehicles that have different numbers of seats on the left and right sides. When the location information is set using the above-described method of the present embodiment, the occurrence of such problem can be avoided.

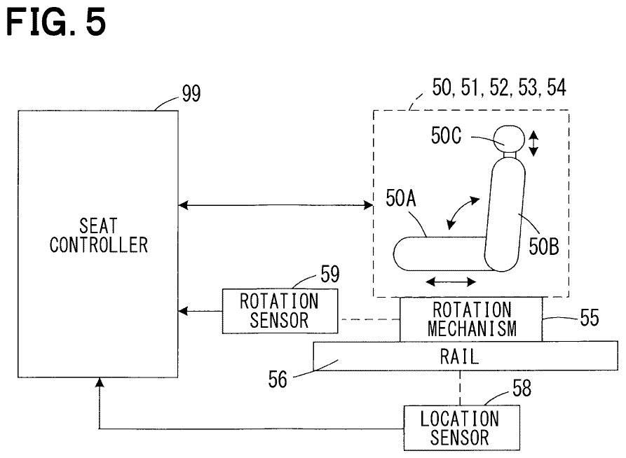

The seats 50 to 54 installed in the vehicle A of the present embodiment are configured as electric power seats. As shown in FIG. 5, a well-known electric power seat can be moved forward and backward by an actuator such as an electric motor. The actuator can further adjust a height of the seat surface 50A, a reclining angle of the backrest 50B, a height of the headrest 50C, etc.

In response to a command from the body system controller 84, the seat controller 99 adjusts the slide position, seat height, reclining angle, or headrest position of the electric power seat, which provides each of the seats 50 to 54, and outputs an adjustment result to the body system controller 84.

Each of the seats 50 to 54 is installed in the vehicle compartment via a rotation mechanism 55 that supports the electric power seat in a rotatable manner. The rotation mechanism 55 supports each of the seats 50 to 54 so that the seat can rotate around a central axis in the height direction of the vehicle A. The user can use this rotation mechanism 55 to change an orientation of each of the seats 50 to 54 from the standard forward direction to the left or right lateral direction.

The rotation mechanism 55 is provided with a locking mechanism (not shown). The locking mechanism is configured to lock each of the seats 50 to 54 so that the rotation of the seat is disabled. The user can rotate the seats 50 to 54 by unlocking the locking mechanism.

Rails 56 are arranged on the floor of the vehicle A for moving the seats 50 to 54 in the front-rear and left-right directions. The rotation mechanism 55 is movably provided on the corresponding rails 56. Therefore, each of the seats 50 to 54 can be moved back and forth or left and right within the vehicle compartment to change the seat location, as the seat 53 shown in FIG. 2. The orientation of seat can be changed by rotating the seat.

The rotation and movement of each of the seats 50 to 54 using the rotation mechanism 55 and rails 56 is performed manually by a user. For this reason, the rotation mechanism 55 or the rails 56 are provided with a location sensor 58 and a rotation sensor 59 for detecting the location and orientation of each of the seats 50 to 54. The detection signals from the sensors 58, 59 are also input to the seat controller 99, and then output from the seat controller 99 to the body system controller 84.

The body system controller 84 can obtain the state of each seat 50 to 54 from the adjustment result of each seat 50 to 54 input from the seat controller 99. The body system controller 84 can obtain the location and orientation of each seat 50 to 54 from the detection result detected by the location sensor 58 and the rotation sensor 59.

The rotation and movement of each of the seats 50 to 54 may be performed using an actuator such as an electric motor, rather than being performed manually by the user. In this case, the location and orientation of each of the seats 50 to 54 change according to the operation of the actuator. Thus, parameters for operation can be obtained from the actuator without using the sensors. The location and orientation of each of the seats 50 to 54 may be detected based on an image captured by a camera installed inside the vehicle compartment.

Management data for each of the seats 50 to 54 of the vehicle A may be stored in the memory 32 of the ECUE 30, which is included in the body system controller 84. The management data includes identification information ID set for each of the seats 50 to 54 installed in the vehicle A, lateral location information and row location information of each of the seats 50 to 54, and spatial coordinates of each of the seats 50 to 54.

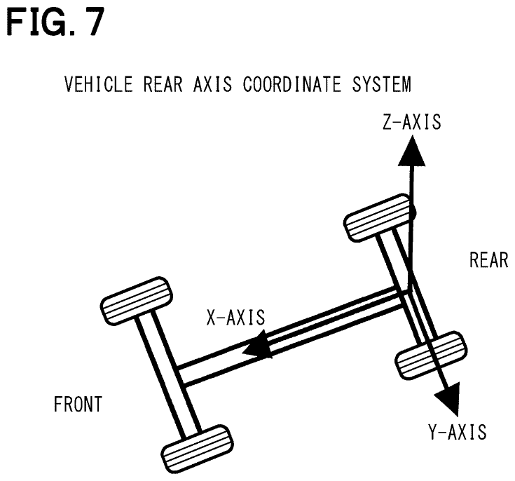

As shown in FIG. 7, for example, the spatial coordinate system is defined in a vehicle rear axis coordinate system with an origin at the midpoint between the left and right wheels on the rear side of the vehicle, and an axis extending in the front-rear direction of the vehicle from the origin as the X-axis, an axis extending in the left-right direction as the Y-axis, and an axis extending in the up-down direction as the Z-axis are set in the spatial coordinate system. Note that the spatial coordinates in the X-axis direction correspond to the row spatial coordinates in the present disclosure, and the spatial coordinates in the Y-axis direction correspond to the lateral spatial coordinates in the present disclosure.

Since the location of each of the seats 50 to 54 is adjusted by the operation of the electric power seat, the management data stores, as spatial coordinates, an initial location, which corresponds to a reference, and a current location after the location has been adjusted.

Each of the seats 50 to 54 can be stowed by setting the reclining angle of the backrest 50B to 0 degrees. The management data may include stow state information indicating whether each of the seats 50 to 54 is stowed or not. The management data may include information about the reclining angle, slide position, headrest position, for each of the seats 50 to 54.

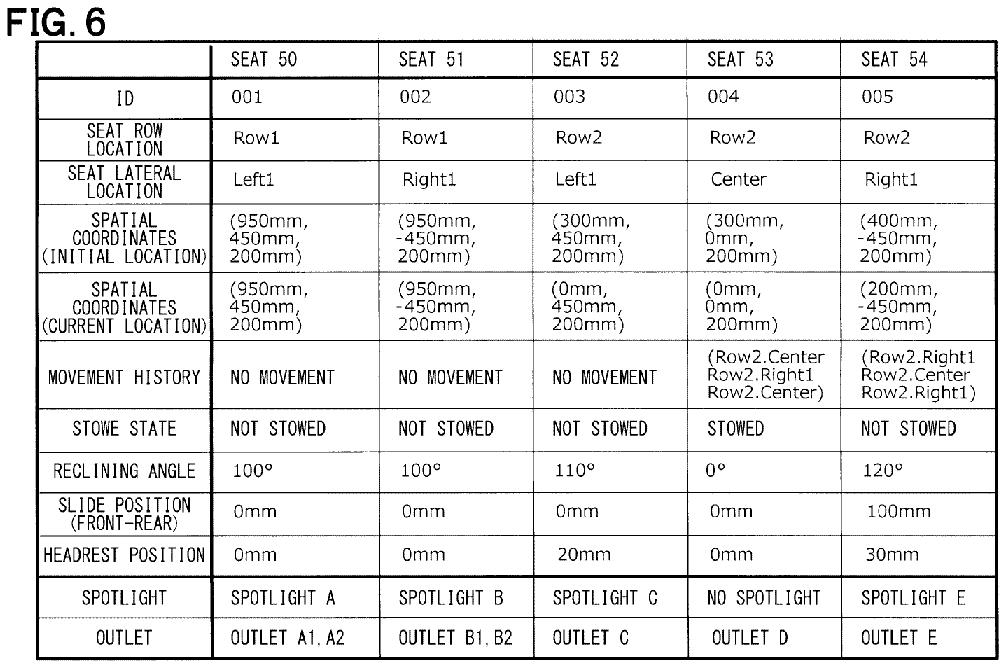

Other vehicle components such as air conditioning outlets, spotlights, etc. may be located near each of the seats 50 to 54. For this reason, for the management data of each of the seats 50 to 54, information on the air outlets and spotlights arranged near the corresponding seat 50 to 54 may be included as attribute information, as shown in FIG. 6. Therefore, from the location information of each of the seats 50 to 54, other vehicle-mounted components, such as air outlets and spotlights linked to the corresponding location information can also be identified.

Each of the seats 50 to 54 can be moved forward, backward, left and right using the rails 56, thereby changing the seat location. The seat location can be specified by the location information. Therefore, in the management data, the location information of the moved seat is rewritten, and the movement history of the corresponding seat is updated.

The ECUE 30 of the body system controller 84 detects the movement of seat based on the detection signal from the location sensor 58, the adjustment result detected by the seat controller 99, or the image captured by the camera. Then, the ECUE 30 of the body system controller 84 obtains the spatial coordinates of the moved seat, and updates the spatial coordinates of the seat included in the management data stored in the memory 32.

The ECUE 30 of the body system controller 84 determines, from the spatial coordinates of the moved seat, the moved seat belongs to which front-to-rear order or left-to-right order in the vehicle. When the front-to-rear order or the left-to-right order of the moved seat is changed, the ECUE 30 updates the row location or lateral location of the seat 501 in the management data.

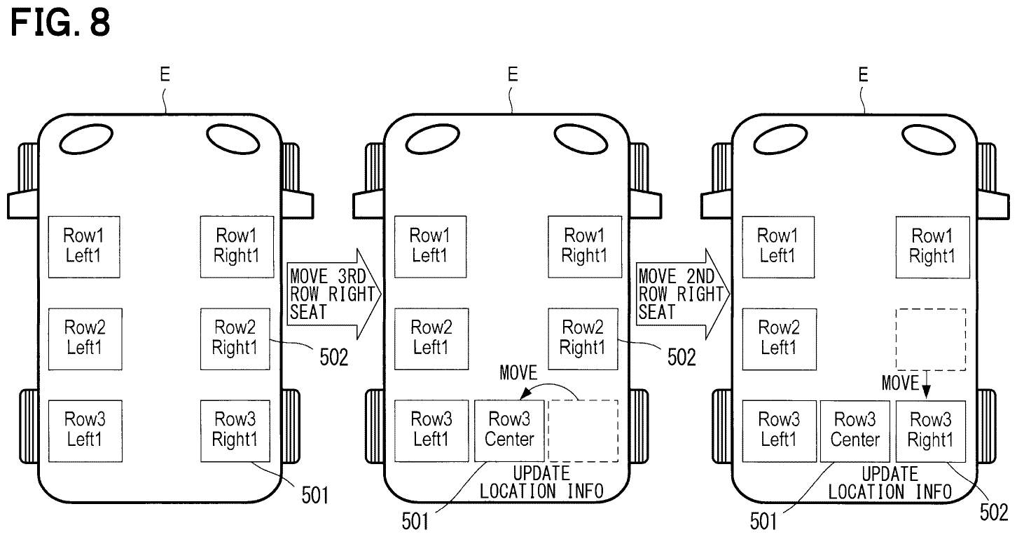

For example, as shown in FIG. 8, when the seat 501 on the right window side of the third row is moved laterally toward the center of the vehicle, the spatial coordinates of seat 501 after the movement are detected based on a detection signal from the location sensor 58, etc., and the spatial coordinates of the seat 501 in the management data are updated.

When the spatial coordinates exceed a preset threshold value for determining order as a result of moving the seat toward the center of the vehicle, the seat 501 is determined to be moved from the right window side to the center, and accordingly the lateral location of seat 501 in the management data is rewritten from “Right 1” to “Center.”

As a result, the location information of seat 501 in the management data is rewritten from “Row 3, Right 1” to “Row 3, Center”, and the location information “Row 3, Center” after change is added to the movement history of seat 501.

As shown in FIG. 8, when the seat 501 close to the right window in the third row is moved to the center of the vehicle and then seat 502 close to the right window in the second row is moved backward, the movement is detected based on a detection signal from the location sensor 58, etc., and the spatial coordinates of seat 502 are updated.

When the spatial coordinates exceed a preset threshold value for determining order as a result of moving the seat rearward, the seat 502 is determined to be moved toward rear side of the vehicle, and accordingly the lateral location of seat 502 in the management data is rewritten from “Row 2” to “Row 3.”

As a result, the location information of seat 502 in the management data is rewritten from “Row 2, Right 1” to “Row 3, Right 1”, and the location information “Row 3, Right 1” after change is added to the movement history of seat 502.

The control of each equipment of the vehicle using the management data and the management and update of the management data are implemented by the functions of body system controller 84.

### Process

The body system controller 84 executes a control process in accordance with a control request from the vehicle service unit 71. In the control process, the body system controller 84 identifies the control target seat or the control target vehicle-mounted component located close to the seat, and performs a control to the identified control target. The control process is implemented by executing a program stored in the memory 32 by the CPU 31 of the ECUE 30. In addition to the control process, the body system controller 84 also monitors seat movement and executes an update process of management data to update the management data.

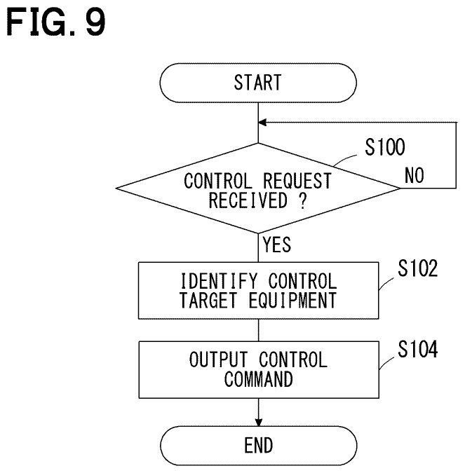

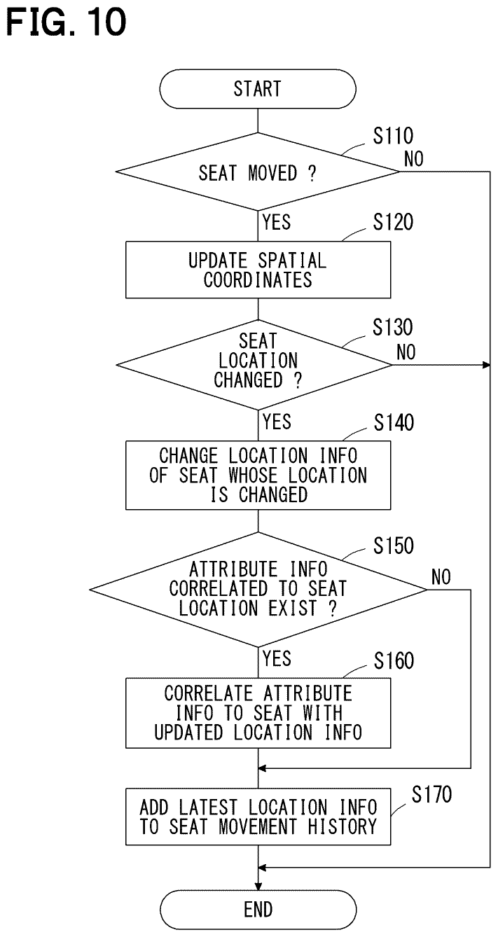

The following will describe the control process using the management data and the update process of management data, which are executed by the body system controller 84, with reference to the flowcharts shown in FIG. 9 and FIG. 10.

As shown in FIG. 9, when the control process starts, in S100, the body system controller determines whether a control request based on management data is received from the vehicle service unit 71, in standby mode.

In S100, in response to determining that a control request is received, the process proceeds to S102. In S102, the body system controller extracts identification information capable of identifying the location of control target from the control request. The identification information identifies the front-to-rear order, which indicates the order in the front-to-rear direction of the vehicle, and the left-to-right order, which indicates the order in the left-to-right direction of the vehicle. In S102, the body system controller detects front-to-rear location and the left-to-right location of the control target relative to the vehicle based on the identification information.

In S102, the body system controller identifies the control target, such as a seat or a vehicle-mounted component correlated to the seat, for example, a spotlight based on the detected location within the vehicle and the management data. The detected location within the vehicle may include the row location and the lateral location within the vehicle. Then, the process proceeds to S104.

In S104, in accordance with the control request, a control command for the seat or vehicle-mounted component, which is identified in S102, is output to the controller corresponding to the control request. The controller corresponding to the control request may be the light controller 97, the HVAC controller 98, or the seat controller 99. Then, the control process is temporarily terminated.

As a result, the light controller 97, the HVAC controller 98, or the seat controller 99 controls the control target in response to the control request.

For example, when a control request to change the reclining angle of the seat on the right window side at the rear of the vehicle is input from the vehicle service unit 71, the seat in the location corresponding to the control request, in this case the seat with location information of “Row 2, Right 1” is identified based on the management data. Then, when a seat corresponding to the control request is identified, a control command to change the reclining angle of the identified seat, in this case seat ID of 005, in accordance with the control request is output to the seat controller 99. As a result, the seat controller 99 adjusts the reclining angle of the seat having the seat ID of 005.

When the seat controller 99 changes the state of seat, such as the reclining angle of the selected seat, in accordance with a command from the body system controller 84, the seat controller transmits the seat state after adjustment to the body system controller 84.

Therefore, the body system controller 84 can update the management data in the memory 37, specifically, information such as spatial coordinates, stow state, reclining angle, slide position, headrest position, etc., in accordance with the seat state transmitted from the seat controller.

Therefore, the management data is updated in accordance with the movement of the electric power seat that constitutes each of the seats 50 to 54, and the body system controller 84 can monitor the state of each seat 50 to 54 based on the updated management data.

When the location or direction of each of the seats 50 to 54 is changed, the body system controller 84 can detect the change based on the detection signal from the location sensor 58 and the rotation sensor 59 or images captured by the camera. When the location or direction of each of the seats 50 to 54 is changed, the body system controller 84 updates the location information and direction information of the corresponding seat in the management data. In the management data shown in FIG. 6, the direction information of each of the seats 50 to 54 is omitted, but the management data may also include direction information indicating the orientation of each seat.

The following will describe, with reference to the flowchart shown in FIG. 10, the update process of management data, which is executed by the CPU 31 of the ECUE 30. The update process of management data is executed when movement of the seat 50 to 54 by the user is detected based on the location sensor 58 or images captured by the camera.

As shown in FIG. 10, in S110, the CPU 31 determines whether the seat is moved by the user operation for moving or rotating the seat. In response to determining in S110 that the seat has been moved, the process proceeds to S120. In S120, the process obtains the spatial coordinates of the moved seat and the spatial coordinates of the seat in the management data stored in the memory 32 are updated.

In S130, the process determines whether the location of seat whose spatial coordinates have been updated in S120 is within the ranges of the row location and lateral location currently identified in the management data. That is, the process determines whether the location of the moved seat belongs to the front-to-back order or left-to-right order currently recognized as the seat location.

In response to determining in S110 that the seat has not been moved or in response to determining in S130 that the seat location belongs to the front-back order and the left-right order currently recognized as the seat location, the management data update process is terminated.

In response to determining in S130 that the seat location does not belong to the front-rear order or the left-right order currently recognized as the seat location, that is, that the seat location is determined to be changed, the process proceeds to S140. In S140, the management data is updated so that the location information of the moved seat, that is, the row location or lateral location corresponds to the current seat location.

After updating the seat location information in the management data in S140, the process proceeds to S150. In S150, the process determines whether there is seat location specific attribute information, i.e., information on spotlight and air outlet, correlated to the updated seat location. In response to determining that there is attribute information specific to the seat location, the process proceeds to S160. In S160, the process correlates the attribute information to the seat so that the attribute information is linked to the seat whose location information has been rewritten.

For example, when a control request to turn on a spotlight located near a seat in the second row on the right window side of vehicle A is input to the body system controller 84, the spotlight to be controlled can be appropriately selected using the management data.

In this case, the body system controller 84 can identify the seat corresponding to the control target spotlight based on the management data, appropriately select the spotlight from the attribute information of that seat, and output a turn-on command to the light controller 97.

In S160, the attribute information is linked to the seat whose location information has been updated, and then the process proceeds to S170. In S150, in response to determining that there is no attribute information specific to the seat location, the process proceeds to S170. In S170, the latest location information is added to the movement history of the seat whose location information has been updated, and the update process of management data is terminated.

### Effects

As described above, in the vehicle control system 1 of the present embodiment, the ECUE 30 has the function of body system controller 84. The memory 32 of the ECUE 30 stores management data representing the seat locations and seat states of the multiple seats 50 to 54 arranged in the vehicle A.

The body system controller 84 uses the management data to identify the control object, that is, the corresponding seat or a vehicle-mounted component linked to the corresponding seat, based on identification information included in the control request input from the vehicle service unit 7. The identification information may be information such as second row, right window side. Then, the body system controller 84 controls the identified control target via the light controller 97, the HVAC controller 98, or the seat controller 99.

When the seat location is changed by the user, the body system controller 84 detects the change in the seat location based on the detection signals from the location sensor 58 and the rotation sensor 59, or the images captured by the camera. Then, the body system controller updates the location information of the corresponding seat. Therefore, even when the seat location is changed, the seat corresponding to control target can be identified using the management data, and then the seat controller 99 can control the identified seat.

The vehicle service unit 7, which inputs the control request to the body system controller 84, or the service application 6 arranged in a higher control layer than the vehicle service unit only needs to input a control request that can identify the location of control target seat in the vehicle. That is, there is no need to generate the control requests based on the specific number and arrangement of the seats in the vehicle.

Therefore, the programs installed in the vehicle service unit 7 and the service application 6 do not need to be prepared for each type of vehicle that has the same number and arrangement of seats, and a common program can be used for different vehicles. According to the vehicle control device system of the present embodiment, it is possible to easily manage the programs used to control the seats and peripheral equipment.

According to the body system controller 84 of the present embodiment, the location information of each of the seats 50 to 54 can be used not only when controlling the seat 50 to 54 configured as the electric power seat, but also when controlling other vehicle-mounted component corresponding to the location of each of the seats 50 to 54.

Therefore, the body system controller 84 can control other vehicle-mounted component linked to each of the seats 50 to 54 in accordance with a control request from the vehicle service unit 7, without managing the location information of the vehicle-mounted component corresponding to each of the seats 50 to 54. Therefore, the configuration of body system controller 84 can be simplified.

In the present embodiment, the memory 32 of the ECUE 30 corresponds to an example of a storage unit of the present disclosure. The body system controller 84, which receives a control request input from the service application 6 via the vehicle service unit 7, corresponds to an example of an input unit of the present disclosure. The body system controller 84 and the seat controller 99, which identify and control the control target seat or the control target vehicle-mounted component in accordance with a control request, correspond to an example of control unit in the present disclosure. The location sensor 58 and the rotation sensor 59 correspond to an example of a detection unit in the present disclosure.

### Modifications

Although the embodiments of the present disclosure have been described above, the present disclosure is not limited to the above embodiments, and various modifications can be made.

In the above embodiment, the control device of the present disclosure is applied to a vehicle control system 1 in which the architecture within the vehicle network is hierarchical in four layers: the service application 6, the vehicle service unit 7, the state management unit 8, and the equipment management unit 9. The control device of the present disclosure can be applied to a control system that controls target equipment in accordance with a control request input from an operation input unit, such as a remote controller as well known, in the same manner as the above-described embodiment.

In the above embodiment, the management data includes, as the location information for each seat, the spatial coordinates representing the seat location within the vehicle and information on the lateral location and row location corresponding to the identification information included in the control request. As another example, the management data may simply include the spatial coordinates within the vehicle as the location information of each seat.

The control target seat or the control target vehicle-mounted equipment corresponding to the seat can be identified and controlled based on the identification information included in the control request and the spatial coordinates of each seat. That is, in this case, when identifying the control target based on the identification information and management data included in the control request in S102 of FIG. 9, the longitudinal and lateral order of the control target within the vehicle identified by the identification information can be associated with the spatial coordinates in the management data.

In the above embodiment, a seat has been used as an example of equipment whose mounting location in the vehicle is managed by the management data. The vehicle-mounted component other than the seats, such as spotlights, air conditioning outlets, windows, etc., may also be considered as control target equipment whose mounting location is managed by the management data. The equipment whose mounting location is managed by the management data may be any vehicle-mounted equipment arranged in the vehicle compartment.

The control target identified by the location information of the management data is not limited to the vehicle-mounted component located close to the equipment whose information is included in the management data, but may be a vehicle-mounted component linked to the equipment whose information is included in the management data. In this case, it is preferable that the control target vehicle-mounted component is set as attribute information of the equipment whose information is included in the management data.

In the above embodiment, the row location information has been described as being set such that the front row of seats at the front portion of the vehicle is defined as Row 1, and the rows are arranged in order from the front toward the rear of the vehicle, as Row 1, Row 2. The lateral location information may also be set in the same manner as the row location information.

As shown in FIG. 11, for equipment arranged front portion relative to the center in the longitudinal direction of the vehicle, the row location information may be set as Front 1, Front 2, . . . in order from the front row of the vehicle. For seats arranged on rear side relative to the center in the longitudinal direction of the vehicle, the row location information may be set as Back 1, Back 2, . . . in order from the rear row of the vehicle.

In this case, the row location information for the seat located at the center in the front-to-rear direction of the vehicle may be set to “Front2 & Back2”, similar to the seat 503 located at the center in the left-to-right direction of the vehicle. In this way, it is possible to determine that the seat is located at the center of the vehicle in the longitudinal direction.

The control device described in the present disclosure may be implemented by a special purpose computer, which includes a memory and a processor programmed to execute one or more special functions implemented by computer programs stored in the memory. Alternatively, the control device described in the present disclosure may be implemented by a special purpose computer configured as a processor with one or more dedicated hardware logic circuits. Alternatively, the control device described in the present disclosure may be implemented by one or more special purpose computers configured by a combination of a processor and a memory programmed to execute one or multiple functions and a processor configured by one or more hardware logic circuits. The computer program may be stored in a computer-readable non-transitory tangible storage medium as instructions to be executed by the computer. The technique for implementing the control device does not necessarily need to include software, and all of the functions may be implemented with the use of one or multiple hardware circuits.

Multiple functions of one configuration element in the above embodiment may be implemented by multiple configuration elements, or a single function of one configuration element may be implemented by multiple configuration elements. Multiple functions of multiple elements may be implemented by one element, one function provided by multiple elements may be implemented by one element. In the above embodiment, a part of the configuration may be properly omitted. Further, at least part of the configuration of the above-described embodiment may be added to or replaced with the configuration of another embodiment described above.

The technology disclosed herein can be implemented in various forms, such as a control device including the above-described ECU, a program for causing a computer to function as the control device, a non-transitory tangible storage medium such as a semiconductor memory on which this program is recorded, and a vehicle control method.

What is claimed is:

1. A vehicle control device comprising:
a storage unit storing location information records indicating mounting locations of multiple pieces of equipment mounted on a vehicle, each of the location information records including row location information indicating a location of the corresponding equipment in a front-rear direction of the vehicle and lateral location information indicating a location of the corresponding equipment in a left-right direction of the vehicle;
an input unit receiving a control request to control one of the multiple pieces of equipment or a vehicle-mounted component correlated to the one of the multiple pieces of equipment, the one of the multiple pieces of equipment being identified by identification information that defines a front-rear order indicating an order in the front-rear direction of the vehicle and a left-right order indicating an order in the left-right direction of the vehicle; and
a control unit determining a control target and performing a control to the control target, the control target being determined as one of the multiple pieces of equipment or the vehicle-mounted component correlated to the one of the multiple pieces of equipment according to the control request based on the identification information included in the control request and the location information stored in the storage unit.

2. The vehicle control device according to claim 1, wherein
the left-right order is set to enable identification of an arrangement order of the equipment from a left end or a right end of the vehicle toward a lateral center of the vehicle.

3. The vehicle control device according to claim 1, wherein
the front-rear order is set to enable identification of an arrangement order of the equipment from a front end or a rear end of the vehicle toward a longitudinal center of the vehicle, or the front-rear order is set to enable identification of the arrangement order of the equipment from a front row of the vehicle toward a rear side of the vehicle.

4. The vehicle control device according to claim 1, wherein
the lateral location information includes lateral spatial coordinates that indicate spatial coordinates in the left-right direction of the vehicle,
the row location information includes row spatial coordinates that indicate spatial coordinates in the front-rear direction of the vehicle, and
the control unit correlates the row spatial coordinates and the lateral spatial coordinates with the left-right order and the front-rear order.

5. The vehicle control device according to claim 1, wherein
the multiple pieces of equipment include a seat located in a passenger compartment of the vehicle in a movable manner by changing a mounting location of the seat,
the seat includes a detection unit that detects the mounting location of the seat in the vehicle, and
the control unit updates the location information of the seat stored in the storage unit corresponding to a change in the mounting location of the seat in response to the detection unit detecting that the mounting location of the seat is changed.

6. The vehicle control device according to claim 5, wherein,
in updating of the location information of the seat stored in the storage unit, when the location information of the seat is correlated to attribute information, which is used to identify the vehicle-mounted component correlated to the seat, the control unit updates the attribute information by correlating the attribute information to the updated location information of the seat.

7. A vehicle control system comprising:
a control device mounted on a vehicle; and
a center device configured to communicate with the vehicle,
wherein
the center device transmits, to the vehicle, a control request to control an equipment mounted on the vehicle or a vehicle-mounted component correlated to the equipment, the equipment being identified by identification information that defines a front-rear order indicating an order in a front-rear direction of the vehicle and a left-right order indicating an order in a left-right direction of the vehicle, and
the control device includes:
a storage unit storing location information records indicating mounting locations of multiple pieces of equipment mounted on the vehicle, each of the location information records including row location information indicating a location of the corresponding equipment in the front-rear direction of the vehicle and lateral location information indicating a location of the corresponding equipment in the left-right direction of the vehicle;
an input unit receiving the control request transmitted from the center device; and
a control unit determining a control target and performing a control to the control target, the control target being determined as one of the multiple pieces of equipment or the vehicle-mounted component correlated to the one of the multiple pieces of equipment according to the control request based on the identification information included in the control request and the location information stored in the storage unit.

8. A control method of controlling a vehicle, the vehicle including a storage unit storing location information records indicating mounting locations of multiple pieces of equipment mounted on a vehicle, each of the location information records including row location information indicating a location of the corresponding equipment in a front-rear direction of the vehicle and lateral location information indicating a location of the corresponding equipment in a left-right direction of the vehicle, the control method comprising:
receiving a control request to control one of the multiple pieces of equipment or a vehicle-mounted component correlated to the one of the multiple pieces of equipment, the one of the multiple pieces of equipment being identified by identification information that defines a front-rear order indicating an order in the front-rear direction of the vehicle and a left-right order indicating an order in the left-right direction of the vehicle; and
determining a control target and performing a control to the control target, the control target being determined as one of the multiple pieces of equipment or the vehicle-mounted component correlated to the one of the multiple pieces of equipment according to the control request based on the identification information included in the control request and the location information stored in the storage unit.

9. A control method of controlling a vehicle, the vehicle including a storage unit storing location information records indicating mounting locations of multiple pieces of equipment mounted on a vehicle, each of the location information records including row location information indicating a location of the corresponding equipment in a front-rear direction of the vehicle and lateral location information indicating a location of the corresponding equipment in a left-right direction of the vehicle, the control method comprising:
receiving, from a center device configured to communicate with the vehicle, a control request to control one of the multiple pieces of equipment or a vehicle-mounted component correlated to the one of the multiple pieces of equipment, the one of the multiple pieces of equipment being identified by identification information that defines a front-rear order indicating an order in the front-rear direction of the vehicle and a left-right order indicating an order in the left-right direction of the vehicle; and
determining a control target and performing a control to the control target, the control target being determined as one of the multiple pieces of equipment or the vehicle-mounted component correlated to the one of the multiple pieces of equipment according to the control request based on the identification information included in the control request and the location information stored in the storage unit.

10. A computer-readable non-transitory storage medium storing a control program for controlling a computer to function as a control device of a vehicle, the vehicle including a storage unit storing location information records indicating mounting locations of multiple pieces of equipment mounted on a vehicle, each of the location information records including row location information indicating a location of the corresponding equipment in a front-rear direction of the vehicle and lateral location information indicating a location of the corresponding equipment in a left-right direction of the vehicle, the control program comprising instructions to control the computer to:
receive a control request to control one of the multiple pieces of equipment or a vehicle-mounted component correlated to one of the multiple pieces of equipment, the one of the multiple pieces of equipment being identified by identification information that defines a front-rear order indicating an order in the front-rear direction of the vehicle and a left-right order indicating an order in the left-right direction of the vehicle; and
determine a control target and perform a control to the control target, the control target being determined as one of the multiple pieces of equipment or the vehicle-mounted component correlated to one of the multiple pieces of equipment according to the control request based on the identification information included in the control request and the location information stored in the storage unit.

11. The vehicle control device according to claim 1, wherein
the identification information is prepared for the vehicle and another vehicle, which has different number and different arrangement of multiple pieces of equipment from the vehicle.
